(19) United States
(12) Patent Application Publication
(10) Pub. No.: US 2003/0038698 A1
(43) Pub. Date: Feb. 27, 2003

(54) Card-type apparatus and method for generating zero magnetic field

(75) Inventor: Masaaki Hirayama, Chofu-shi (JP)

Correspondence Address: KANESAKA AND TAKEUCHI, 1423 Powhatan Street, Alexandria, VA, 22314, US

(73) Assignee: SOS FROM THE EARTH INC. & SUN TECH., CO., LTD.

(21) Appl. No.: 10/218,597

(22) Filed: Aug. 15, 2002

(30) Foreign Application Priority Data
Aug. 24, 2001 (JP) 2001-254969

(51) Int. Cl. H01F 5/00

(52) U.S. Cl. 336/200

(57) ABSTRACT

Card-type apparatus and method for generating a zero magnetic field are disclosed. The generator includes a printed wiring board and a pair of spiral circuits located at corresponding locations on the front and rear sides of the printed wiring board. The winding directions of the spirals are opposite to each other for generating mutually canceling magnetic fields, i.e. a zero magnetic field, upon application of electric current. A through hole is provided through the printed wiring board for connecting the spiral circuits, and a pair of power terminals are provided on the printed wiring board for supplying power to the spiral circuits.

### DETAILED DESCRIPTION OF THE INVENTION

1. Field of Art

This invention relates to card-type apparatus and method for generating a zero magnetic field which generates from a card-shaped body a zero magnetic field, which has effects such as softening of the tastes of refreshment items and moderating the influences of external electromagnetic waves on human bodies.

2. Background Art

Zero magnetic field generators have hitherto been provided for softening the tastes of refreshment items, such as cigarettes and coffee, and lessening their stimulation to the throat. These conventional zero magnetic field generators are fabricated by winding conducting wires clockwise and counter-clockwise on two iron or plastic cores, respectively, in the same number of turns. Upon application of electric current, the wound conducting wires generate mutually canceling magnetic fields to generate a zero magnetic field. When refreshment items are exposed to the environment created by these magnetic fields, external energies applied to these items may be removed.

Such conventional zero magnetic field generators include two opposing iron or plastic cores on which conductive wires are wound for generating a zero magnetic field. The axial lengths of such cores inevitably result in large thickness of the generator, which leads to increased size and weight of the entire product, and causes problems in portability of the product. Further, manually winding conducting wires on iron or plastic cores in the same number of turns is laborsome, and automation of this winding procedure requires a special and expensive winder, which results in increased costs of the entire production system.

The present invention aims to solve the foregoing problems. It is an object of the present invention to provide a card-type zero magnetic field generator which is conveniently thin, portable, and low in cost.

It is another object of the present invention to provide a card-type method of generating a zero magnetic field which does not require a troublesome wire-winding procedure or an expensive wire winder, and which is performed at low cost.

### SUMMARY OF THE INVENTION

According to the present invention, there is provided a card-type zero magnetic field generator comprising:

a printed wiring board having a front side and a rear side;

a pair of spiral circuits each having a central end and a terminal end, said spiral circuits being located at corresponding locations on said front and rear sides of the board with winding directions of spirals being opposite to each other for generating mutually canceling magnetic fields upon application of electric current;

a through hole provided through said printed wiring board for connecting said central ends of said spiral circuits; and

a pair of power terminals provided at said terminal ends of the spiral circuits on said printed wiring board.

The present card-type zero magnetic field generator may optionally include a power supply connected to the power terminals for supplying electric power to the spiral circuits.

The power terminals may alternatively be connected to an electric circuit of an external electric appliance for supply of electric power to the spiral circuits.

The card-type zero magnetic field generator may optionally include a light emitting diode connected to the power terminals. In this embodiment, the light emitting diode lights or flashes during application of electric current to the spiral circuits.

The present generator may optionally include a light emitting diode flashing circuit including a light emitting diode. The light emitting diode flashing circuit may be connected to the power terminals for flashing the light emitting diode during application of electric current to the spiral circuits.

According to the present invention, there is also provided a card-type method of generating a zero magnetic field, comprising:

forming a pair of spiral circuits at corresponding locations on front and rear sides of a printed wiring board, each of said spiral circuits having a central end and a terminal end, said printed wiring board having a central land at a center of spiral on each of said front and rear sides;

forming a through hole in said central lands through said printed wiring board;

providing electrical connection between said central lands on the front and rear sides of the printed wiring board through the through hole;

forming a pair of power terminals at said terminal ends of the spiral circuits; and

applying voltage between said power terminals to generate mutually canceling magnetic fields by the spiral circuits.

### BRIEF DESCRIPTION OF THE DRAWINGS

The present invention will now be explained with reference to the accompanying drawings in which:

FIG. 1 is a plan view of the essential structure of the card-type zero magnetic field generator according to the present invention;

FIG. 2 is a plan view of the rear structure of the embodiment of FIG. 1 seen through the front surface of the generator;

FIG. 3 is a schematic plan view showing a first embodiment of the invention wherein the spiral circuits shown in FIGS. 1 and 2 are connected to a power supply;

FIG. 4 is a wiring diagram of FIG. 3;

FIG. 5 is an explanatory view illustrating the process of forming the spiral circuits shown in FIGS. 1 and 2;

FIG. 6 is an explanatory view illustrating the process of forming a through hole in the central lands at the center of the spiral circuits shown in FIGS. 1 and 2;

FIG. 7 is a schematic plan view showing a second embodiment of the invention wherein the spiral circuits shown in FIGS. 1 and 2 are connected to a power supply and an LED;

FIG. 8 is a wiring diagram of FIG. 7;

FIG. 9 is a schematic plan view showing a third embodiment of the invention wherein the spiral circuits shown in FIGS. 1 and 2 are connected to a power supply and an LED flashing circuit;

FIG. 10 is a wiring diagram of FIG. 9;

FIG. 11 is a schematic plan view showing a fourth embodiment of the invention wherein the spiral circuits shown in FIGS. 1 and 2 are connected to a power supply and an LED flashing circuit;

FIG. 12 is a wiring diagram of FIG. 11;

FIG. 13 is a wiring diagram showing the details of the LED flashing circuit of FIG. 12;

FIG. 14 is a perspective view, partially broken-out, of a card-type zero magnetic field generator accommodated in a case;

FIG. 15 is a perspective view of a card-type zero magnetic field generator accommodated in a case;

FIG. 16 is a perspective view of a card-type zero magnetic field generator in use according to the present invention; and

FIG. 17 is a wiring diagram showing a use of another embodiment of a card-type zero magnetic field generator according to the present invention.

### PREFERRED EMBODIMENT OF THE INVENTION

Preferred embodiments of the present invention will now be explained with reference to the accompanying drawings.

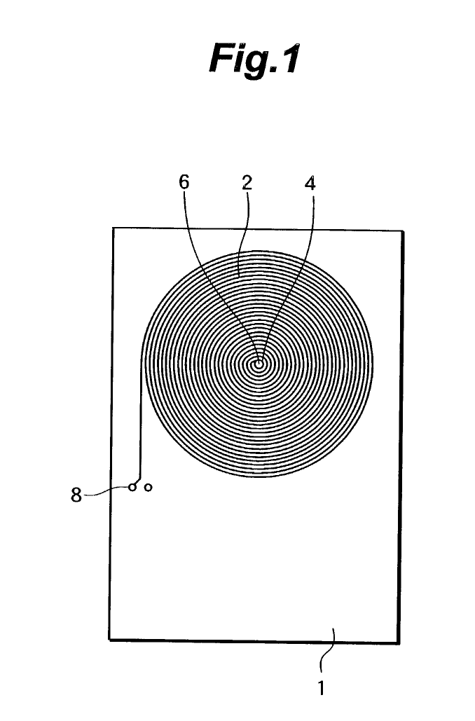

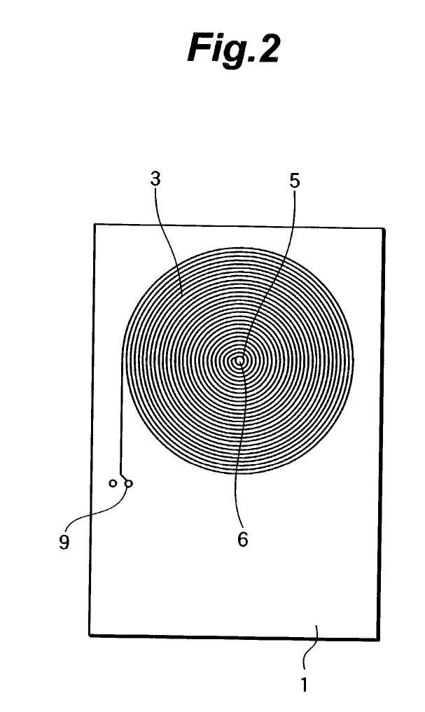

Referring to FIGS. 1 and 2, a card-type zero magnetic field generator of the present invention includes a printed wiring board 1, and a pair of conductive circuits 2 and 3 in the form of flat coils (spirals) printed as patterns on the front and rear surfaces, respectively, of the board 1. The printed wiring board 1 may have a thickness, for example, of about 0.1 mm. This structure realizes reduced thickness and weight of the entire product, and makes the product portable.

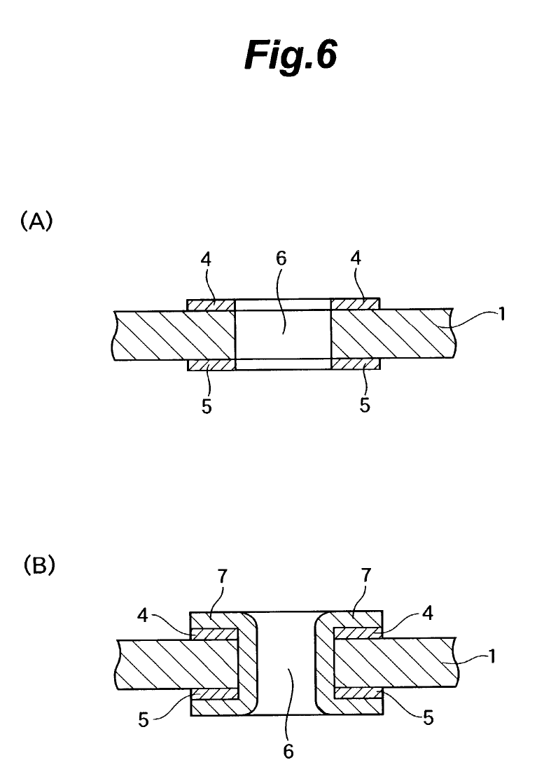

The spiral circuits 2 and 3 have the same number of turns, shapes, and dimensions, and are arranged at the corresponding locations on the front and rear surfaces of the board 1, respectively, in registration with each other. Lands 4 and 5 are provided on the front and rear sides of the printed wiring board 1 in the center of the spiral circuits 2 and 3, respectively. Through the central lands 4 and 5, a central hole 6 is provided through the printed wiring board 1 as shown in FIG. 6(A). Over the inner surface of the central hole 6 is provided a plating layer 7 as a conductive layer as shown in FIG. 6(B). One end, i.e., the central end, of the spiral circuit 2 is electrically connected to one end, i.e., the central end, of the spiral circuit 3 via the central lands 4 and 5 and the plating layer 7. In other words, the central lands 4 and 5 are connected with each other via the through hole 6.

Instead of the plating layer 7, the inner surface of the central hole 6 may be covered with an eyelet fit in the hole 6, or electrically conductive paint filling the hole 6, for providing the electric connection mentioned above.

The spiral circuit 3 on the rear surface of the printed wiring board 1 is shown in FIG. 2 as having the same winding direction as that of the spiral circuit 2 on the front surface of the board 1. However, when seen from the rear surface, the circuit 3 has the opposite winding direction from that of the circuit 2.

The other ends, i.e., the terminal ends, of the spiral circuits 2 and 3 are connected to power terminals 8 and 9, respectively, in the form of lands printed as patterns on the front and rear surfaces of the board 1, respectively. Each of these lands 8 and 9 is connected via a through hole to a lead pattern to be discussed later.

The spiral circuits 2 and 3 may be formed by printing a resist layer in a spiral pattern on a copper foil provided on an insulating substrate, subjecting the substrate to etching to remove the exposed copper foil portions, and removing the resist layer. With this process, the circuits 2 and 3 may be formed rapidly with high precision, which realizes mass-production of the generator. Further, dimensional errors due to manual and mechanical operations are completely eliminated, and the process has little fraction defective.

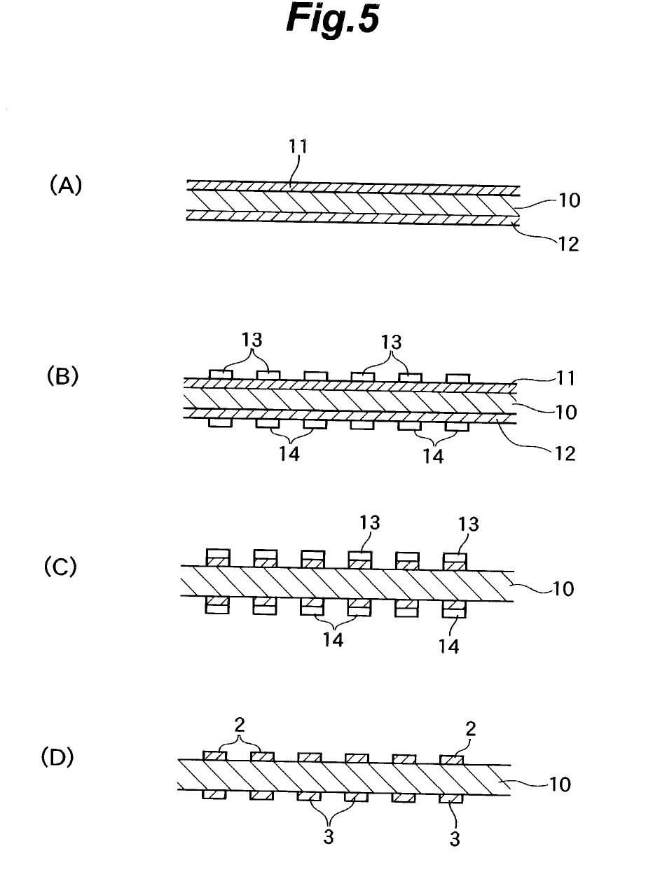

Referring to FIG. 5, the process of forming the spiral circuits 2 and 3 is explained in detail. First, on the front and rear surfaces of an insulating substrate 10, copper foils 11 and 12 are provided, respectively (FIG. 5(A)). On the copper foils 11 and 12, spiral patterns are printed with a printing ink 13, 14 to form resist layers (FIG. 5(B)). Then the exposed portions of the copper foils 11 and 12 are removed by etching (FIG. 5(C)), and subsequently the printing ink 13, 14 is removed. In this way, the spiral circuits 2 and 3 as mentioned above are obtained (FIG. 5(D)).

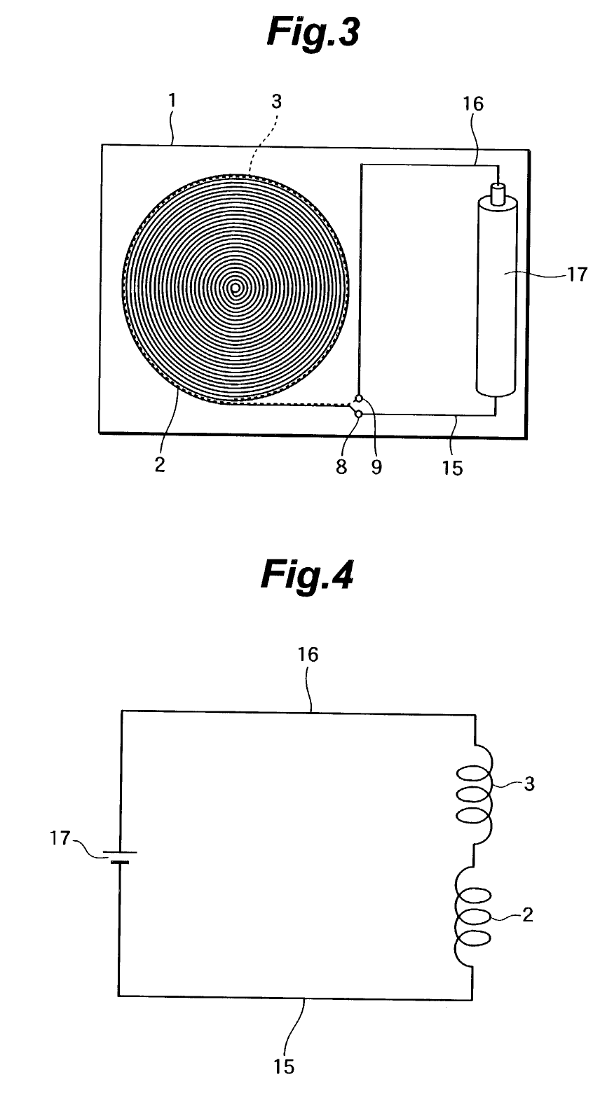

The card-type zero magnetic field generator of the present invention also includes lead patterns 15 and 16 formed on one surface of the printed wiring board 1 and connected at one ends to the power terminals 8, 9, respectively, as shown in FIG. 3. The other ends of the lead patterns 15 and 16 are connected to a battery 17, such as a button type battery, as a power supply via a power switch (not shown). For the purpose of explanation only, the battery 17 is shown as a dry cell in the drawings. FIG. 4 is a wiring diagram of the card-type zero magnetic field generator including the lead patterns 15 and 16, battery 17, and the spiral circuits 2, 3. In FIG. 3, the spiral circuit 3 on the rear surface of the board 1 is shown in dotted line. The battery 17 may be an alkaline, manganese, solar, lithium, or rechargeable battery.

In this card-type zero magnetic field generator, on turning the power switch on, the source voltage is applied via the lead patterns 15 and 16 to the spiral circuits 2 and 3, each of which generates a magnetic field corresponding to the number of turns (same number) of the coil. Since these circuits 2 and 3 are located at corresponding locations on the front and rear surfaces of the printed wiring board 1, respectively, such that the winding directions of the spirals are opposite to each other, the circuits 2 and 3 generate mutually canceling magnetic fields to generate a zero magnetic field. The size of this magnetic field depends on the volume of the electric current flowing through the spiral circuits. The area covered by this zero magnetic field is made to be a space that is not affected by the environmental magnetic field.

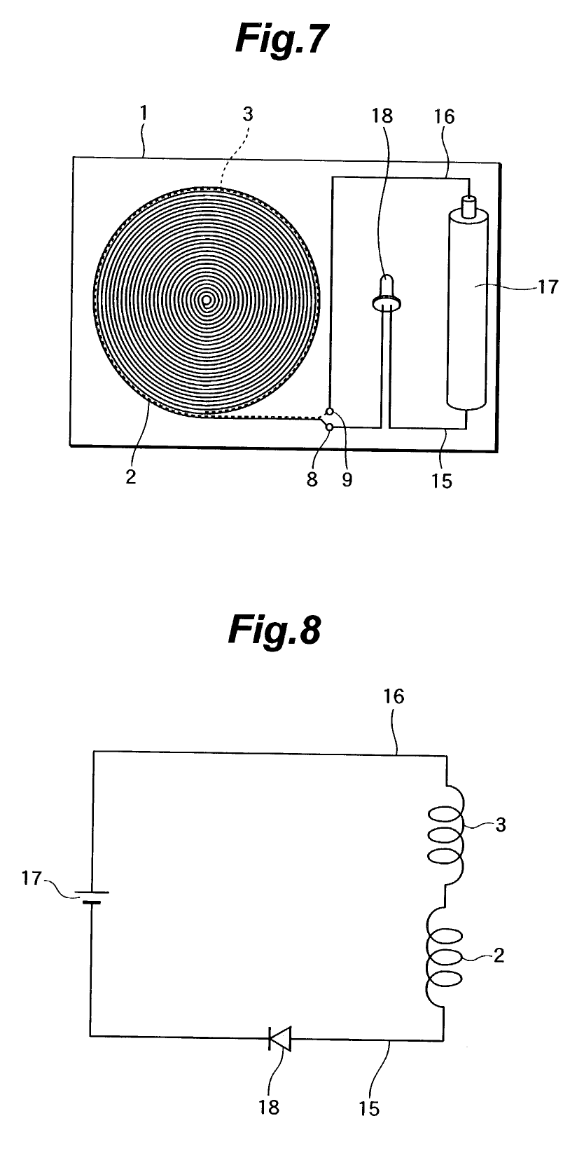

FIGS. 7 and 8 are schematic plan view and wiring diagram, respectively, of an embodiment wherein a light emitting diode (LED) 18 is provided in the middle of the lead pattern 15 in the card-type zero magnetic field generator of FIGS. 3 and 4. In this embodiment, while the energized spiral circuits 2 and 3 are generating a zero magnetic field, the LED 18 is lit with the electric current flowing through the circuits. This structure enables the user to visually confirm that the card-type zero magnetic field generator is in operation.

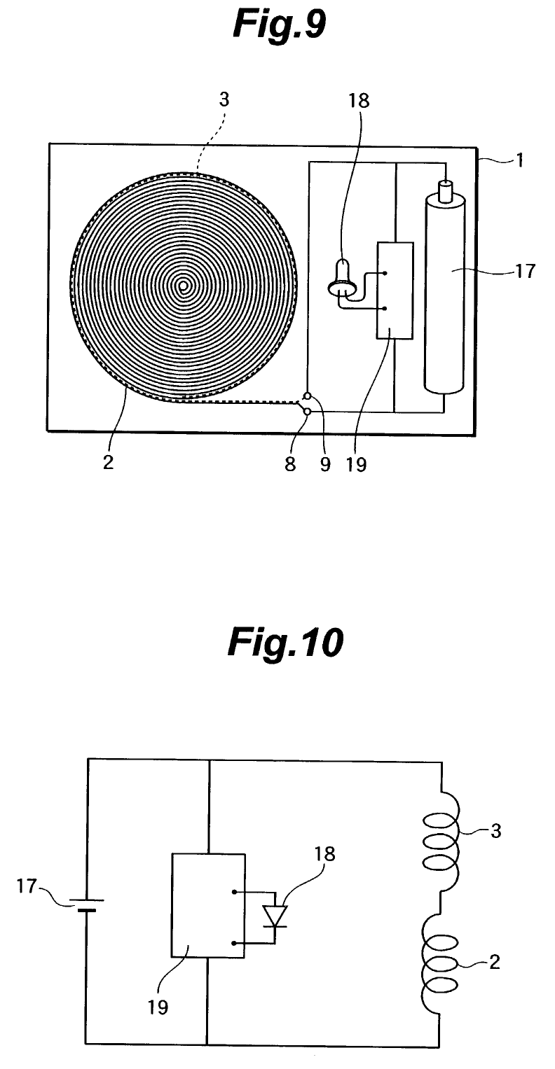

FIGS. 9 and 10 show another embodiment wherein an LED flashing circuit 19 is provided between the lead patterns 15 and 16 of FIG. 3. This LED flashing circuit 19 generates intermittent pulse voltage, which makes the LED 18 flash. With this structure, exhaustion of the battery 17 by the LED 18 is suppressed by flashing the LED 18 during the operation of the spiral circuits 2 and 3.

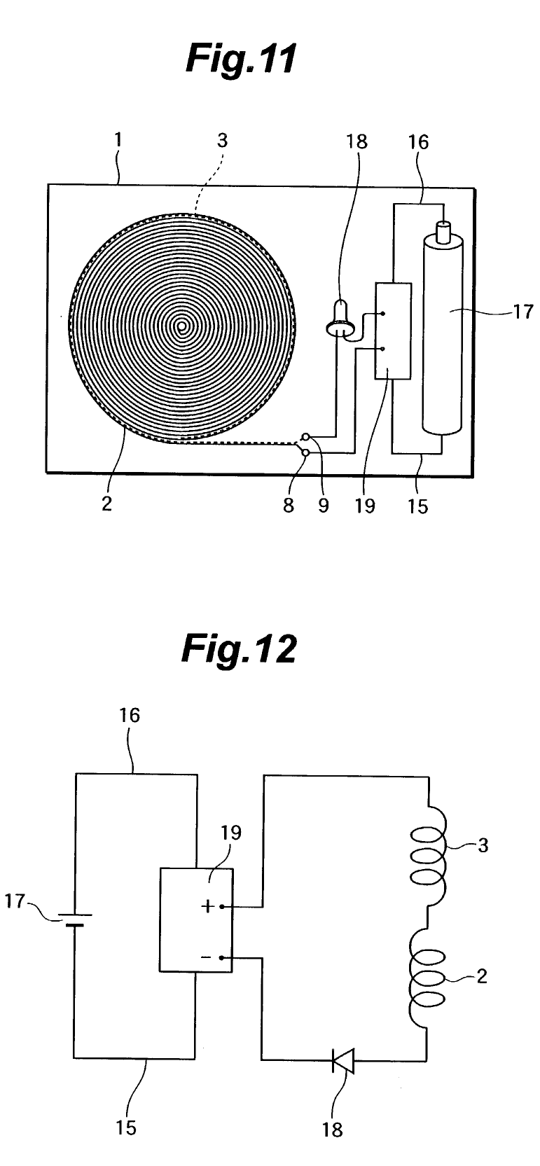

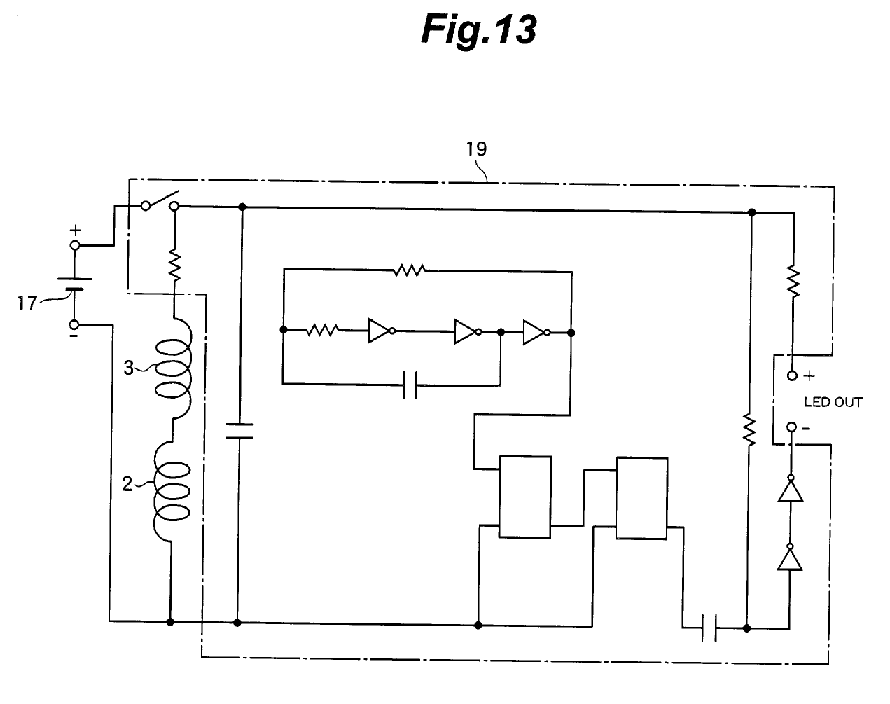

FIGS. 11 and 12 show yet another embodiment wherein the LED flashing circuit 19 and the LED 18 are connected in series with the lead patterns 15 and 16 of FIG. 3 to make the LED 18 flash at predetermined intervals as in the previous embodiment. With this structure, when either one of the LED 18 and the LED flashing circuit 19 fails, for example by rupture, operation of the other is also stopped, to thereby prevent wasteful power consumption. FIG. 13 is a wiring diagram illustrating the details of the LED flashing circuit 19, which includes a flashing pulse circuit of a basically resistance-capacitance type.

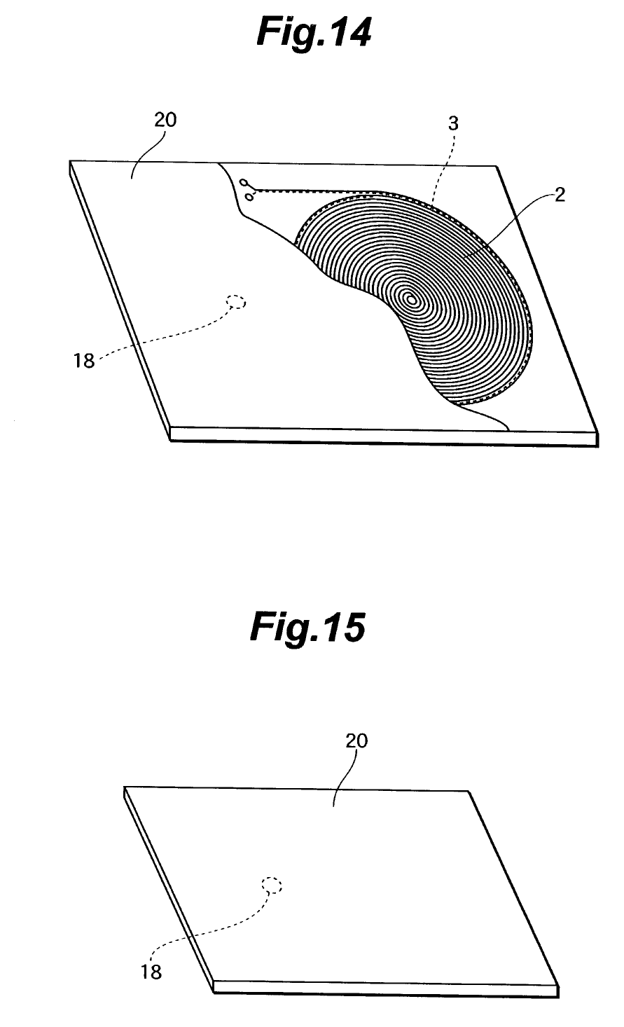

The card-type zero magnetic field generator having the above structure is preferably encased in a transparent or translucent plastic case 20 in its entirety, as shown in FIG. 14. The case 20 is provided with a lid (not shown) for allowing access to the battery 17 as a power source for replacement. An operation knob for the power switch (not shown) attached to the printed wiring board 1 extends out of the case 20. Thus the power switch may be operated readily. The case 20 also covers and protects the internal system in its entirety as shown in FIG. 15. The case 20 is in the form of a card having, for example, a thickness of 3 mm, and is portable.

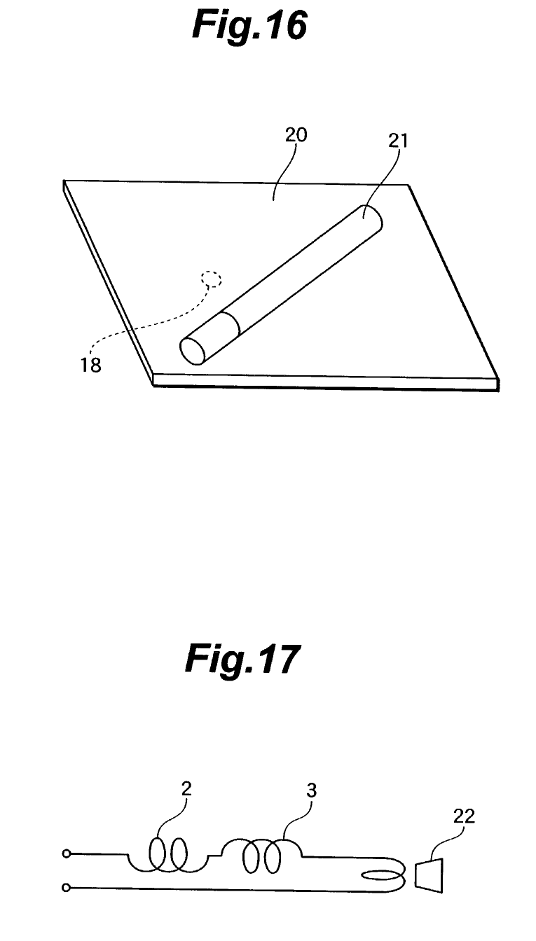

Since the card-type zero magnetic field generator of the present invention is constructed as described hitherto, when, for example as shown in FIG. 16, a cigarette 21 is placed on the case 20, and the power supply is switched on to apply electric current through the spiral circuits 2 and 3 for 1 to 2 minutes, a zero magnetic field is generated, which makes the taste of the cigarette 21 mild, and moderates its stimulation to the throat. Similarly, when a cup of coffee is placed on the case 20 to expose the coffee to the zero magnetic field, the bitter taste of the coffee becomes mild. Further, when the case 20 is placed in a vehicle cabin, the generated zero magnetic field makes the cabin an energy space, which puts the life energy of the driver in good order, and mitigates the driver's stress, contributing to safety driving.

Recently in the industry relating to wave motion (energetic vibration), wave motion cards and information water are used. When such a wave motion card or information water is placed on the case 20, the energy of the information input in the card or the water is added, and the information is realized or the wave motion of the information water is intensified, so that the energy level may be raised. When the case 20 is placed near electric appliances such as televisions, protection against the adverse effects of the electromagnetic waves generated by the electric appliances may be provided. In this way, the generator of the present invention may improve the wave motion of a substance, recover the original taste, provide protection against adverse effects of external electromagnetic waves, and improve functions of, for example, vehicle engines.

At present, such improvement in the wave motion of the wave motion cards or information water due to the energy of the zero magnetic field, can only be measured with wave motion measuring devices, aura photographs, or Kirlian photographs, which are not yet recognized in medicine or chemistry. With these means, however, remarkable difference in human body conditions is observed between when the present card-type zero magnetic field generator is used and when not used. Table 1 shows the results of measurement of wave motion after smoking of a cigarette that has been or has not been placed on the present generator, using a wave motion measuring device, MIRS (Magnetic Inspired Resonance Spectrum).

TABLE 1

| | Before Use of | After Use of |
|---|---|---|
| | Present Generator | Present Generator |
| 1 Immunity | −1 | +21 |
| 2 Pharynx | +3 | +21 |
| 3 Lungs | +2 | +21 |
| 4 Master Gland | +1 | +19 |
| 5 Stress | +5 | +21 |

The wave motion measuring device, MIRS, detects by sound whether the wave motion emitted by the object of the measurement is in resonance or in non-resonance with the operator. The value at which the sound changes from a resonant sound to a non-resonant sound is measured, and taken as the wave motion value. The resonant sound is bright and energetic, while the non-resonant sound is dull and makes you feel as if you are loosing energy. According to the wave motion measurement, the measured values +18 or higher indicate very high wave motion, +15 to +18 relatively high, +10 to +14 normal, +5 to +9 low, and −21 to +4 very low. The higher the numerical values, the higher the wave motion and the better the influence on human body. For example, comparing stress +5 and stress +21, the latter indicates less stress.

In another embodiment, the power terminals 8 and 9 of the card-type zero magnetic field generator may be connected to an antenna of a cellular phone, and the current of the electric wave received by the antenna is rectified and conducted to the spiral circuits 2 and 3 to generate a zero magnetic field. With this structure, the harmful electric wave received by the antenna may be made harmless, and the receiving sensitivity and transmission output may be improved. When an LED is provided in the circuit connecting the antenna to the series circuit including the spiral circuits 2 and 3, reception and transmission may be observed visually.

Further, the card-type zero magnetic field generator of the present invention may be attached to straps for cellular phones, key holders, pendants, ear rings, pierced earrings, watches, clocks, ornaments, bibelots, figurines, or the like, to make the harmful electromagnetic waves harmless.

In another embodiment, the power terminals 8 and 9 of the card-type zero magnetic field generator may be connected in series with speakers of a headphone, as shown in FIG. 17. The zero magnetic field generated by the spiral circuits 2 and 3 improves the soundscape, provides relaxing and refreshing effects, and produces a restful space. In this embodiment, the card-type zero magnetic field generator does not have a battery as a power supply of its own, and the output current from the amplifier flows through the spiral circuits 2 and 3.

Further, when the card-type zero magnetic field generator is connected to the circuit of, or is placed near electromagnetic cooking devices, keep-warm plates, microwave ovens, disposers, electric pots, washing machines, refrigerators, speakers, hearing aids, or the like, the environment of the electromagnetic waves at certain frequencies generated by these electric appliances may be adjusted to an environment of a zero magnetic field. Thus the electric appliances may be operated efficiently, and the harmful effects of the generated electromagnetic waves on human body and substances near the appliances may be avoided.

As discussed above, with the card-type zero magnetic field generator of the present invention, a zero magnetic field may be generated in a certain area from a portable, thin, and light body to improve the tastes of refreshment items, safen harmful electromagnetic waves emitted from electrical appliances, improve soundscape of audio devices, improve receiving sensitivity of cellular phones, increase horse power of vehicle engines, increase gasoline mileage, and reduce engine noise.

When the card-type zero magnetic field generator of the present invention is optionally provided with an LED that lights or flashes during application of electric current to the spiral circuits, generation of a zero magnetic field may readily be observed visually, and the power switch may be operated as desired for saving power consumption. In addition, when an LED flashing circuit is optionally provided, the LED may be made to flash, to thereby effectively suppress exhaustion of the battery.

When the power terminals of the card-type zero magnetic field generator of the present invention are connected to an electric circuit of an external electric appliance, operational environment of the electric appliance may be improved, and efficient operation may be achieved.

With the card-type method of generating a zero magnetic filed according to the present invention, various items and substances, such as refreshment items, electric appliances, vehicles, and accessories, may be put in good order when placed in the zero magnetic field generated by this method.

A zero magnetic field has no magnetic force, but only has energy generated by application of electric current. Thus when cigarettes or coffee is placed in the zero magnetic field, the taste of the cigarettes or coffee is softened due to the generated energy.

Since the zero magnetic field generator of the present invention is in the form of a card, the entire thickness and weight of the device are reduced to improve portability in a breast pocket, a handbag, or a business card case. Thus this generator may conveniently be used anywhere.

When the zero magnetic field generator of the present invention is placed in a vehicle cabin, the energy generated by the generator may have an influence on the engine to improve the horse power, acceleration, and gasoline mileage, and reduce the engine noise.

Although the present invention has been described with reference to the preferred embodiment, it should be understood that various modifications and variations can be easily made by those skilled in the art without departing from the spirit of the invention. Accordingly, the foregoing disclosure should be interpreted as illustrative only and is not to be interpreted in a limiting sense. The present invention is limited only by the scope of the following claims.

What is claimed is:

1. A card-type zero magnetic field generator comprising:
a printed wiring board having a front side and a rear side;
a pair of spiral circuits each having a central end and a terminal end, said spiral circuits being located at corresponding locations on said front and rear sides of the board with winding directions of spirals being opposite to each other for generating mutually canceling magnetic fields upon application of electric current;
a through hole provided through said printed wiring board for connecting said central ends of said spiral circuits; and
a pair of power terminals provided at said terminal ends of the spiral circuits on said printed wiring board.

2. The card-type zero magnetic field generator of claim 1, further comprising a power supply connected to said power terminals for supplying electric power to the spiral circuits.

3. The card-type zero magnetic field generator of claim 1, wherein said pair of power terminals are connected to an electric circuit of an external electric appliance.

4. The card-type zero magnetic field generator of claim 3, wherein said external electric appliance is selected from the group consisting of an electromagnetic cooking device, keep-warm plate, microwave oven, disposer, electric pot, washing machine, refrigerator, speaker, and hearing aid.

5. The card-type zero magnetic field generator of claim 1, further comprising a light emitting diode connected to said power terminals, wherein said light emitting diode lights or flashes during application of electric current to said spiral circuits.

6. The card-type zero magnetic field generator of claim 1, further comprising a light emitting diode flashing circuit including a light emitting diode, said light emitting diode flashing circuit being connected to said power terminals for flashing said light emitting diode during application of electric current to said spiral circuits.

7. A card-type method of generating a zero magnetic field, comprising:
forming a pair of spiral circuits at corresponding locations on front and rear sides of a printed wiring board, each of said spiral circuits having a central end and a terminal end, said printed wiring board having a central land at a center of spiral on each of said front and rear sides;
forming a through hole in said central lands through said printed wiring board;
providing electrical connection between said central lands on the front and rear sides of the printed wiring board through the through hole;
forming a pair of power terminals at said terminal ends of the spiral circuits; and
applying voltage between said power terminals to generate mutually canceling magnetic fields by the spiral circuits.
